(19) United States
(12) Patent Application Publication
(10) Pub. No.: US 2013/0275416 A1
(43) Pub. Date: Oct. 17, 2013

(54) SCORING OF RESOURCE GROUPS

(71) Applicants: Rodney A. Thomson, Westminster, CO (US); Brian J. Reynolds, Erie, CO (US)

(72) Inventors: Rodney A. Thomson, Westminster, CO (US); Brian J. Reynolds, Erie, CO (US)

(73) Assignee: AVAYA INC., Basking Ridge, NJ (US)

(21) Appl. No.: 13/444,461

(22) Filed: Apr. 11, 2012

(51) Int. Cl. G06F 17/30

(52) U.S. Cl. 707/723; 707/E17.071

(57) ABSTRACT

Methods and systems for automatically providing a relevancy score with respect to reports or groups of resources are provided. In particular, a proposed report or group of resources is input or otherwise defined by a user. The proposed report is then compared to predefined reports. A relevancy score for each of a plurality of predefined reports with respect to the proposed report is calculated and output to the user. The relevancy score can be reported as a percentage.

### FIELD

The present invention is directed to the scoring of resource groups. More particularly, embodiments provide a relevancy score for an existing group of resources relative to a proposed group of resources.

### BACKGROUND

In various applications, supervisors or administrators require access to data regarding administered resources. For example, in a contact or call center, a supervisor, operations manager, data analyst or other contact center administrator may consider a list or group of contact center agents or other resources, such as queues and routing points. The list can be contained in or comprise a report that is generated by the system and output to the user. In various applications, the user may be interested in grouping the resources because they have something in common that makes them interesting as group. Before creating a new group, however, the user may want to determine if there is an existing group that can be used for reporting on this particular set of agents.

In a typical system, the user creates resource groups to satisfy the needs of the user. Typically, this is a manual process. In addition, the process of culling and updating groups is typically performed manually. As more groups are created, it becomes more and more difficult for the user to determine which groups are in use, and which groups are no longer valuable. Therefore, although systems can provide a view of existing groups and the members of those groups to a user, there is no convenient means by which a user can determine whether an existing group can be usefully applied to a new or proposed group of resources.

### SUMMARY

Systems and methods that provide a relevancy score for existing resource groups relative to a proposed group of resources are provided. More particularly, embodiments of the present invention compare existing groups of resources to a proposed group of resources, and generate a relevancy score or ranking. Using the generated relevancy score, a user can determine or is assisted in determining whether an existing group will satisfy their immediate needs. Alternatively, the relevancy score can be used to assist a user in identifying an existing group that, through a minimal amount of modification, can be made suitable for an immediate need.

Methods in accordance with embodiments of the present invention can include identifying a proposed group of resources. The proposed group of resources can be a list of contact center agents or other resources, such as queues and routing points, created by the user or some other party or means. The method additionally includes identifying at least a first predefined group of resources. A relevancy score of at least the first predefined group of resources relative to the proposed group of resources is then determined or generated. The determined relevancy score is then reported to the user. The relevancy score can comprise a ratio of the number of members of the proposed group of resources that are included in a predefined or preexisting group of resources to the total number of members of the predefined group of resources. Moreover, this score can be expressed as a percent. Methods can additionally include modifying a relevancy score based on whether the predefined group of resources can be edited or not in order to meet the user's needs. In addition, the score can be based on all members, or only active members.

Systems implementing embodiments of the present disclosure can provide application programming that is operable to present a determined relevancy score to a user. The application programming can include a reporting and relevancy application. The reporting and relevancy application can be implemented in connection with a server computer and/or a client computer. The reporting and relevancy application can provide or operate in connection with a user interface that receives input from and presents information to a user, such as an administrator. Through the user interface, the user can input the members of a user selected or proposed group of resources. The reporting and relevancy application programming can then generate a relevancy score from a comparison of the proposed group of resources to a predefined or existing group of resources. The determined relevancy ranking or score can then be output to the user, for example through the user interface.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting components of a system in accordance with embodiments of the present invention;

FIGS. 2A-2B are block diagrams of a contact center server and a supervisor device respectively in accordance with embodiments of the present invention;

FIG. 3 depicts a user interface in accordance with embodiments of the present invention; and

FIG. 4 is a flowchart depicting aspects of a method in accordance with embodiments of the present invention.

### DETAILED DESCRIPTION

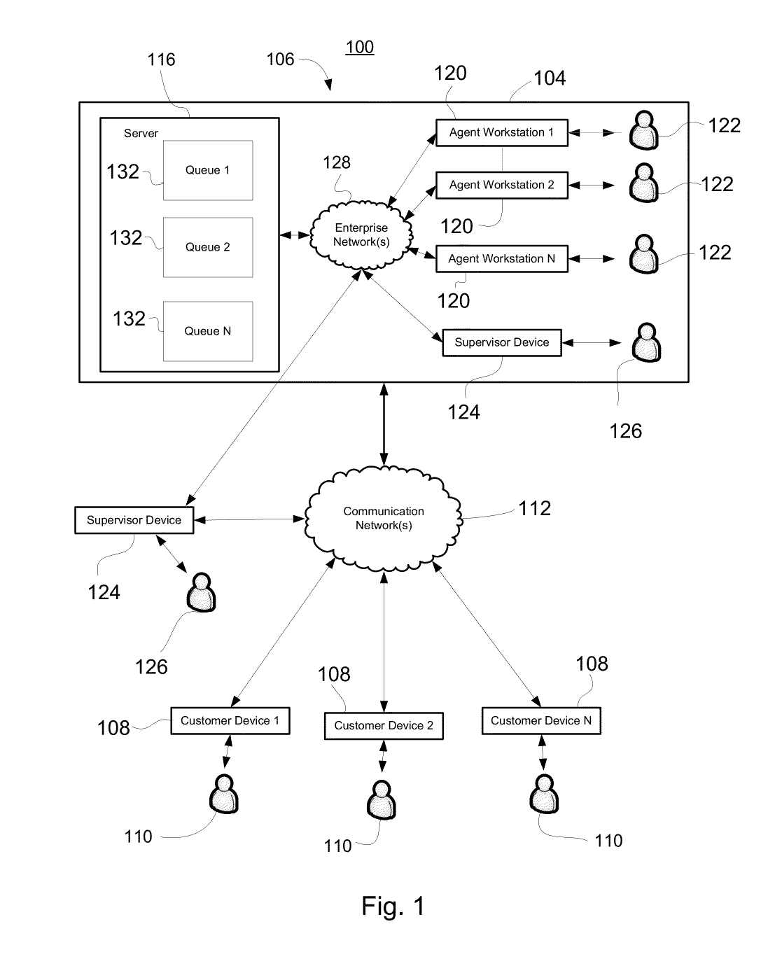

FIG. 1 is a block diagram depicting components of a communication or other system 100 in accordance with embodiments of the present invention. In particular, the communication system 100 includes one or more sub-systems or collections of resources. Accordingly, the communication system includes a number of resources 106. As an example, a sub-system can comprise a call or contact center 104. Although the description will refer to the collection of resources as a contact center 104, the example of a contact center is not intended to limit the claims. Instead, embodiments of the present disclosure can be applied to any collection of resources that can be represented as a list of resources including a number of member resources. In addition, although a single contact center 104 is shown, a communication system 100 can have any number of contact centers 104. Resources can include any element or aspect of a communication or other system 100. For instance, in the example of a contact center 104, resources can include agent workstations 120, human agents 122, contact center queues 132, processors, processing devices, communication links, communication bandwidth, routing points, or any other element or resource. In general, the contact center 104 can be in communication with one or more customer endpoints or devices 108 via one or more communication networks 112. Examples of customer endpoints 108 include but are not limited to telephones, cellular telephones, and desktop or mobile computing devices, or any other device capable of supporting communications between a customer and a customer service or other agent associated with the contact center 104. Moreover, the communications between the contact center 104 and the customer endpoints 108 can comprise voice telephony, video telephony, email, instant messaging, short message system, or other real time or non-real time communications. The communication network 112 can include the Internet, local area network, wide area network, public switched telephony network (PSTN), wireless networks, or a plurality of networks in any combination. The contact center 104 generally includes a call or contact center server 116, such as an automatic contact (or call) distribution system (ACD) server 116. The ACD server 116 is illustratively the Avaya Aura® Call Center Elite enterprise communication-based ACD system. The ACD server 116 is interconnected to a plurality of agent workstations or endpoints 120. The agent workstations 120 may be connected to the ACD server 116 by a voice and/or data transmission medium or enterprise network 128. Although an ACD server 116 is discussed, in keeping with the example of a contact center 104, it should be appreciated that the ACD server 116 can alternately comprise any system server or node of a communication or other system 100. Therefore, the example of an ACD server 116 is not intended to limit the claims.

The ACD server 116 generally functions to connect agent workstations 120 to customer devices or endpoints 108 through the communication network 112, to place customers 110 in communication with agents 122. In addition, the ACD server 116 maintains queues 132 for servicing customer calls or other contacts. The different queues 132 can be used to sort contacts from (or to) customer endpoints 108 by type, identity of the customer 110 or contact, or any other attribute. Agents 122 associated with the agent workstations 120 are assigned to provide services to contacts that have been placed within one or more of the queues 132 based on availability and/or weighting factors.

In addition, embodiments of a communication system 100 can include a supervisor or administrator device or workstation 124. The supervisor device 124 is in communication with the ACD server 116 via the communication network 112 and/or the enterprise network 128. For example, if the supervisor device 124 is on the premises of the contact center 104, communications with the ACD server 116 may be over a portion of the enterprise network 128 comprising a wireless (e.g., a Wi-Fi) network. As another example, the supervisor device 124 may be in communication with the ACD server 116 over the communication network 112, for example via a cellular telephony data network, a Wi-Fi or a wired Ethernet connection outside of the enterprise network 128. In general, the supervisor device 124 provides functionality that allows a supervisor or other user 126 to monitor the health of the contact center 104, and to control aspects of the operation of the contact center 104.

The supervisor device 124 can comprise any device, including a mobile device, capable of presenting information to a supervisor 126, and of receiving control commands from the supervisor 126. In addition, the supervisor mobile device 124 is generally a device capable of running an application that provides a browser, template or framework for displaying information and receiving input with respect to such information. In addition, the supervisor device 124 is a device that is capable of wired or wireless communications over at least one of a variety of network types, including but not limited to cellular data networks (such as 3G or 4G networks), Wi-Fi networks, WiMax networks, Bluetooth connections, Ethernet networks, and the like. Accordingly, a supervisor device 124 can include, but is not limited to, a desktop computer, a tablet computer, a laptop computer, a Smartphone, a Netbook, a desktop computer, or the like.

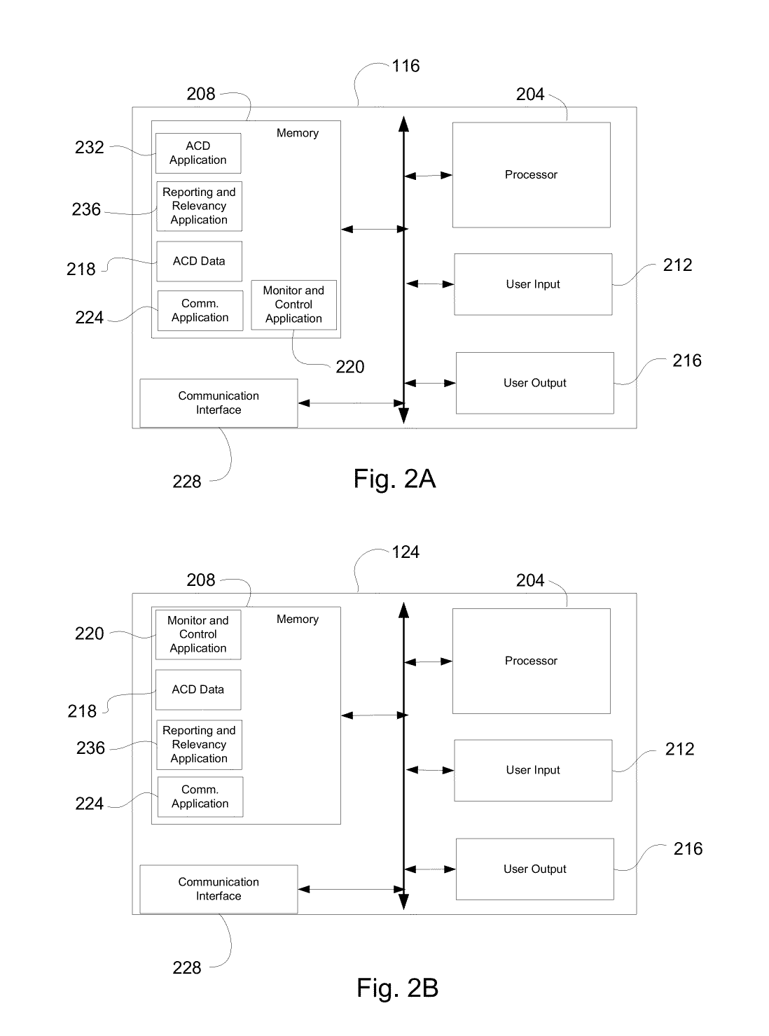

FIGS. 2A-2B are block diagrams depicting components of an ACD system 104 in accordance with embodiments of the present invention. More particularly, components of an ACD server 116 are shown in FIG. 2A, while components of a supervisor device 124 are shown in FIG. 2B.

As the ACD server 116 and the supervisor device 124 can, at least partially, be implemented as conventional computing devices, they share certain components in common. For example, each generally includes a processor 204 capable of executing program instructions. The processor 204 may include any general purpose programmable processor or controller, such as but not limited to a processor implemented in hardware, for executing application programming. Alternatively, the processor 204 may comprise a specially configured application specific integrated circuit (ASIC). The processor 204 generally functions to run programming code implementing various functions performed by the associated ACD server 116 or supervisor device 124. For example, with respect to the ACD server 116 (see FIG. 2A), the processor 204 can implement functions including assigning incoming contacts received by the contact center 104 from customer endpoints 108 to contact queues 132 and to agent workstations 120 for handling by associated agents 122. The processor 204 can also operate in connection with application programming to generate reports regarding predetermined or selected groups of resources 106 included in the system 100. Moreover, as described in greater detail elsewhere herein, the processor 204 of the ACD server 116 can generate a relevancy ranking with respect to a predetermined group of resources 106 as compared to a proposed group of resources 106 received from a supervisor 126 or other user. As another example, with respect to the supervisor device 124 (see FIG. 2B), such functions may include displaying information regarding the operation of the communication system 100 and/or an included call center 104 to the supervisor 126, and to receiving commands input by the supervisor 126 with respect to the operation of a contact center 104. Moreover, as described in greater detail elsewhere herein, the ACD server 116 and the supervisor device 124 operate in cooperation with one another to provide monitoring and control functions to a supervisor 126, to assist in the operation of the contact center 104. These functions can additionally include receiving input from the supervisor 126 or other user regarding a proposed group of resources 106, and displaying or otherwise presenting a relevancy ranking from a comparison of a predefined group of resources 106 to a proposed group of resources 106. In accordance with still other embodiments, the generation of a relevancy score can be performed by the processor 204 of the supervisor device 124, in cooperation with application programming included in the supervisor device 124 and/or the ACD server 116.

The ACD server 116 and the supervisor device 124 additionally include memory 208. The memory 208 can be used in connection with the execution of programming by the processor 204 of the associated device 116 or 124, and for the temporary or long term storage of data or program instructions. For example, the ACD server 116, as shown in FIG. 2A, can include a monitor and control application 220 and/or an automatic call distribution application 232 that is stored in memory 208. As an additional example, the ACD server 116 can operate in connection with the operation of a reporting and relevancy ranking application 236 stored in the memory 208 that functions as an adjunct to or in cooperation with the ACD call distribution application 232. The memory 208 of the ACD server 116 can also function as a store for records or other data 218 that is related to the ACD or contact queues 132 maintained by the ACD server 116. The memory 208 included in the supervisor device 124, as shown in FIG. 2B, can include a monitor and control application 220. As described in greater detail elsewhere herein, the monitor and control application 220, whether implemented on one or both of an ACD server 116 or a supervisor device 124, can provide a user interface to display information regarding the operation of the ACD system 104 to the supervisor 126 or other user, and to receive control input from the supervisor 126 or other user. The memory 208 in the supervisor device 124 can also provide storage for ACD system 104 data 218. A reporting and relevancy ranking application 236 can also be stored in the memory 208 of the supervisor device 124, as an alternative to or in addition to a reporting and relevancy ranking application 236 in the memory 208 of the ACD server 116. A reporting and relevancy ranking application 236 can operate in cooperation with a monitor and control application 220 and/or an ACD call distribution application 232. The memory 208 of the ACD server 116 and/or the supervisor mobile device 124 can additionally provide storage for one or more communication applications 224. Examples of communication applications 224 include, but are not limited to, email, instant messaging, voice telephony, video telephony, and the like. The memory 208 of the ACD server 116 and/or the supervisor mobile device 124 can include solid state memory that is resident, removable and/or remote in nature, such as DRAM and SDRAM. Alternatively or in addition, the memory 208 can include magnetic, optical or other storage devices. Moreover, the memory can include a plurality of discrete components of different types and/or a plurality of logical partitions.

In addition, user input devices 212 and user output devices 216 may be provided. With respect to the ACD server 116, such devices 212 and 216 can be used in connection with the monitoring and control of the ACD system 104 by a supervisor 126 or an administrator in a conventional fashion, in which the supervisor 126 or administrator is tethered to the contact center 104. With respect to the supervisor device 124, the one or more user input devices 212 or one or more user output devices 216 facilitate the remote monitoring and control of the ACD system 104 by the supervisor 126 through the supervisor device 124. Examples of user input devices 212 include a keyboard, a numeric keypad, touch screen, microphone, scanner, and pointing device combined with a screen or other position encoder. Examples of user output devices 216 include a display, a touch screen display, a speaker, and a printer. As can be appreciated by one of skill in the art, a touch screen display may comprise a combined user input 212 and user output 216 device. The ACD server 116 and the supervisor mobile device 126 also generally include a communication interface 228 to interconnect the server 116 or device 126 to the networks 112 and 128.

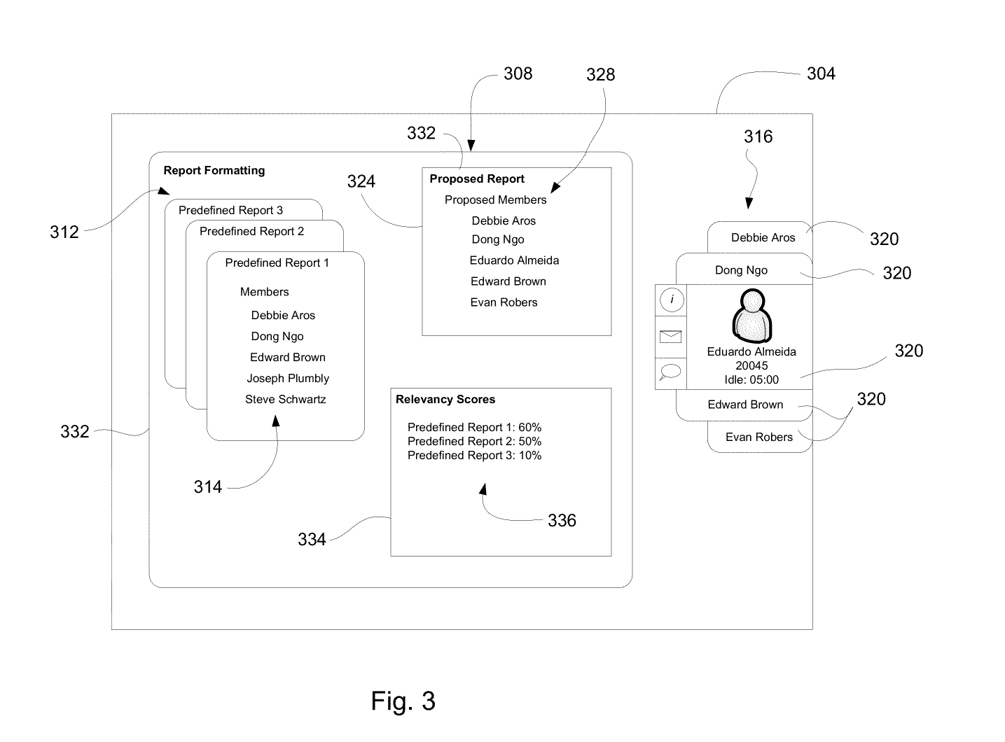

FIG. 3 depicts an exemplary page or screen that can be presented to a supervisor 126 or other user by a user interface 304 in accordance with embodiments of the present invention. The user interface 304 can be generated through operation of the reporting and relevancy ranking application 236 on the contact center server 116 within the communication system 100, and/or in connection with the reporting and relevancy ranking application 236 running on the supervisor device 124. The user interface 304 can display information generated by the monitor and control application 220, the ACD application 232, the reporting and relevancy ranking application 236 and/or stored as ACD data 218. The user interface 304 can be presented by a user output 216 of a contact center server 116 and/or a supervisor device 124. Moreover, the user interface 304 can be interactive, in that it can provide fields, regions, buttons, menus, or other features to enable the user interface to receive input from a supervisor or administrator 126, including input concerning the control of a contact center 104, as well as to present information to the supervisor 126 textually and/or graphically.

More particularly, the user interface 304 can include a report formatting area 308. The report formatting area 308 can present various information or sets of information.

Such information can include information regarding predefined, predetermined, or preexisting reports 312. Predefined reports 312 may be stored in memory 208 as part of ACD system data 218, as part of application data, or as a separate data item or set. As part of the predefined reports 312, member resources 314 comprising the members included in the predefined reports 312 can be presented. Accordingly, predefined reports 312 can comprise or relate to predefined groups or resources. As an example, the member resources 314 can comprise human agents 122 associated with a contact center 104. The report formatting area 308 can additionally include a proposed report field 324. A supervisor 126 or other user can enter proposed resources 328 as members of a proposed report 332. Accordingly, a proposed report 332 can comprise or be related to a user entered groups of resources. In addition, the report formatting area 308 can provide a relevancy score area 334 containing relevancy scores 336 generated through operation of a reporting and relevancy ranking application 236 from a comparison of the proposed report 332 to predefined reports 312. The user interface 304 can, for example and without limitation, comprise a touch screen display 212, 216. The user interface can also present a set or stack of agents 316, in which individual agents 122 are each represented by a tile 320. The set of agents 316 can include a representation of all of the agents 122 associated with the contact center 104. Alternatively, the set of agents 316 can include those agents 122 who are candidates for assignment to a selected queue 132, and/or who are already assigned to a selected queue 132. The set of agents 316, as a further alternative, can include those agents 122 identified as a result of the performance of a search or the application of a filter implemented or initiated in response to input from the supervisor 126. Moreover, the user interface 304 can allow or provide a means by which a supervisor 126 can identify or select the resources or members 328 of a proposed report 332 from the set of agents 316.

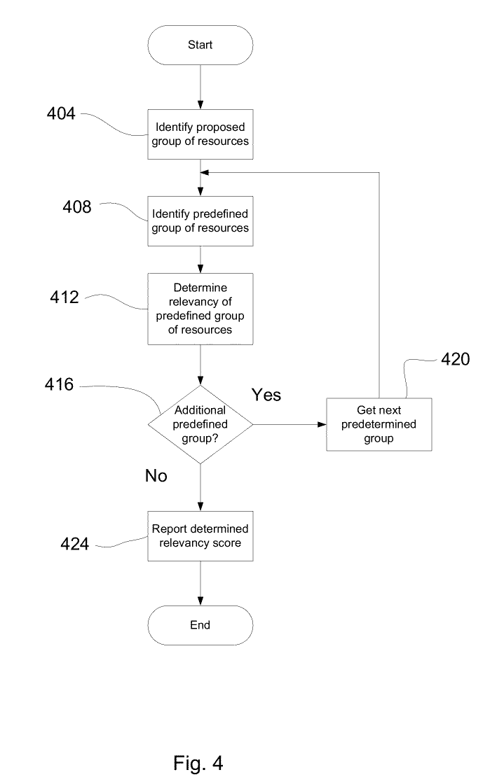

With reference now to FIG. 4, aspects of a method for reporting and relevancy ranking in accordance with embodiments of the present disclosure are depicted. Initially, at step 404, a proposed group of resources 328 is identified. The proposed group of resources 328 can comprise a proposed report or group or resources 332 entered through a user interface 304 by a supervisor 126 or other user. The members of the proposed group of resources 332 can comprise individual contact center agents 122. Other resources can be included in a proposed group or resources 332. For example, in a contact center 104 context, in addition or as an alternative to contact center agents 122, the report members 328 can comprise queues 132 routing points, etc. In other contexts, other report members 328 can be selected. For example, any resource included in or associated with a system 100 can be selected.

At step 408, a predefined group of resources or a predefined report 312 can be identified. The identification can be in the form of input received through a user interface 304 from a supervisor 126 or other user. Alternatively, the system can operate automatically to select a predefined group 312 from those groups previously established in connection with a reporting and relevancy ranking application 236, through operation of that application 236.

At step 412, the relevancy of the identified predefined group of resources 312 with respect to the proposed group of resources 322 is determined. This determination can be made through operation of the reporting and relevancy ranking application 236. In accordance with embodiments of the present disclosure, the relevancy can be determined based on the degree of overlap between the identified predefined report or group of resources 312 and the proposed report or group of resources 322. The relevancy score 336 can be reported as a percentage of overlap. In accordance with at least some embodiments of the disclosed invention, a relevancy score 336 is calculated from a ratio of the number of members 328 of the proposed group of resources 332 that are included in as members 314 of the predefined report or set or resources 312. In calculating the relevancy score of a predetermined report 312, inactive group members can be included. Alternatively, inactive group members can be excluded. Whether inactive group members are included in or excluded from the calculation or determination of the relevancy score can also be determined by the user. As yet another alternative, whether inactive group members are included or not can be specified by the user at runtime, like a dynamic filter.

The determination of a relevancy score can also include determining whether the user has the ability to edit an existing group or report 312. More particularly, an edit factor can be applied when less than 100% of the proposed or initial group of resources 328 are included in the members 314 of a predefined report 312. If the user can edit the predefined report 312, for example to add missing resources to create a new group, the edit factor applied is 100%. The edit factor has no effect on the relevancy score when the edit factor is 100%. If the match is less than 100% and the user 126 cannot edit the predefined report 312, the edit factor would be some value less than 100%, and is applied to the relevancy score. For example, if the relevancy score is 60% with respect to a predefined report 312 and the user 126 cannot edit that predefined report 312, after application of the edit factor the relevancy score will be from anywhere between 0% and 60%, where the edit factor is set from 0% to 100% respectively. For instance, if the edit factor is 50%, a calculated 60% relevancy score will become a 30% relevancy score after application of the edit factor. The use of an edit factor can result in higher relevancy scores for predefined reports groups or resources 312 that can be edited by the user 126, as compared to predefined reports or groups or resources 312 that otherwise have the same initial relevancy score but that can't be edited.

At step 416, a determination can be made as to whether there are additional predefined reports 312 available from the ACD system data 218, from the relevancy and ranking application 326, or some other associated application on the system 100. If additional predefined reports 312 remain to be scored relative to the proposed report or group of resources 322, a next predefined report 312 can be selected (step 420), and the process can return to step 408, to allow the relevancy of the proposed group 322 to be scored relative to the next predefined report 312. The selection of a next predefined report 312 can be performed automatically or in response to input from the user.

Once all of the predefined reports 312 have been scored for relevancy relative to the proposed report or sets of resources 322, the determined relevancy scores for each of the predefined reports 312 can be output or reported to the user 126 (step 424). Reporting or outputting the relevancy score 336 can be performed through the user interface 304. For example, the relevancy score may be presented for each predefined report 312 in the system 100 or for which the user 126 has read rights. In accordance with other embodiments, only those predefined groups for which the user has read rights and for which some minimum relevancy score has been calculated may be included in the report of relevancy scores that are presented to the user. The report can also include additional information, such as information identifying the predefined reports 312, and an indication as to whether a predefined report 312 included in the report of relevancy scores can be edited by the user 126.

Although various examples have been presented in the context of a contact center, embodiments of the present disclosure are not limited to such applications. For example, systems and methods as disclosed herein for providing a relevancy score of preexisting reports or groups of resources with respect to a proposed report or group of resources can be implemented in connection with any collection of resources for which reports are generated.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

1. A method, comprising:
identifying a proposed group of resources, wherein the proposed group of resources identifies each individual resource included in the proposed group;
identifying at least a first predefined group of resources;
determining a relevancy score of the at least a first predefined group of resources relative to the proposed group of resources, wherein the determined relevancy score of the first predefined group of resources is a ratio of the number of members of the proposed group of resources that are included in the first predefined group of resources to the total number of members of the first predefined group of resources; and
reporting the determined relevancy score of the at least a first predefined group of resources to a user.

2. The method of claim 1, wherein identifying at least a first predefined group of resources includes identifying at least the first predefined group of resources and a second predefined group of resources from a set containing a plurality of predefined groups of resources.

3. The method of claim 2, further comprising:
determining a relevancy score of the second predefined group of resources relative to the proposed group of resources;
reporting the determined relevancy score of the second group of resources to the user.

4. The method of claim 3, wherein the user has at least read permission with respect to the first and second predefined groups of resources, and wherein the determined relevancy score of the second predefined group of resources is a ratio of the number of members of the proposed group of resources that are included in the second predefined group of resources to the total number of members of the second predefined group of resources.

5. (canceled)

6. The method of claim 3, wherein the user does not have access privileges to the second predefined group of resources, wherein a determined relevancy score of the second predefined group of resources is not reported to the user.

7. (canceled)

8. The method of claim 1, further comprising:
determining whether the user has editing privileges with respect to the first predefined group of resources;
in response to determining that the user has editing privileges with respect to the first predefined group of resources, modifying the relevancy score of the first predefined group of resources by an edit factor.

9. The method of claim 8, wherein the edit factor is expressed as a percent.

10. The method of claim 1, wherein the proposed group of resources includes at least one of: a human agent, a queue, a routing point, a processing resource, a communication server, and a communication endpoint.

11. A non-transitory computer readable medium having stored thereon computer executable instructions, the computer readable instructions causing a processor to execute a method for evaluating resource groups, the computer readable instructions comprising:
instructions to receive input from a user identifying at least a first proposed group of resources;
instructions to identify at least a first predefined group of resources;
instructions to determine a relevancy of the at least a first predefined group of resources to the proposed group of resources;
instructions to report the determined relevancy of the at least a first predefined group of resources to the proposed group of resources to the user as a relevancy score; and
instructions to modify the relevancy score reported to the user with respect the first predetermined group of resources by an edit factor.

12. The computer readable medium of claim 11, further comprising:
instructions to identify a second predefined group of resources;
instructions to determine a relevancy of the second predefined group of resources to the proposed group of resources;
instructions to report the determined relevancy of the second predefined group of resources to the proposed group of resources to the user as a relevancy score.

13. The computer readable medium of claim 12, wherein the user has access rights with respect to the first and second predefined groups of resources.

14. The computer readable medium of claim 13, wherein the instructions to determine a relevancy of the first and second groups of resources to the proposed group of resources includes instructions to derive the number of members of the proposed group of resources that are in the first group of resources and instructions and to derive the number of members of the proposed group of resources that are in the second group of resources.

15. The computer readable medium of claim 14, wherein the instructions to determine a relevancy of the first and second groups of resources further includes determining a ratio of the total number of group members of the first predetermined group to the number of members of the proposed group of resources included in the first predetermined group of resources, and determining a ratio of the total number of group members of the second predetermined group to the number of members of the proposed group of resources included in the second predetermined group of resources.

16. The computer readable medium of claim 15,
wherein the relevancy score for the second predetermined group is not modified by the edit factor, wherein the user has editing privileges with respect to the first predetermined group, and wherein the user does not have editing privileges with respect to the second predetermined group.

17. A system, comprising:
a plurality of resources;
a server, wherein the plurality of resources are interconnected to the server, the server including:
a processor;
memory;
application programming stored in the memory and executed by the processor, wherein information related to the resources included in at least a first predetermined group of resources is maintained by the server, wherein the application programming is operable to receive a selected list of resources from a user, wherein the application programming is operable to determine a relevancy score of at least the first predetermined group of resources relative to the selected list of resources, and wherein the application programming is operable to modify the determined relevancy score of at least the first predetermined group of resources in the response to the application programming determining that the user has editing privileges with respect to the first predetermined group of resources;
a user interface running on at least one of the server and an administrator device, wherein the user interface is operable to present the determined relevancy score to the user.

18. The system of claim 17, further comprising:
an administrator device, including:
a communication interface, wherein the communication interface interconnects the administrator device to the server;
a user output;
a user input;
a processor;
memory;
application programming, wherein the application programming is operable to present the determined relevancy score to the user.

19. The system of claim 18, wherein the plurality of resources includes a plurality or human agents, wherein the server includes a contact center server, and wherein the information related to the first predetermined group of resources maintained by the server includes information about the human agents.

20. The system of claim 19, wherein information related to the resources included in at least a second predetermined group of resources is maintained by the server, wherein the application programming is operable to determine a relevancy score of at least the second predetermined group or resources relative to the user selected list of resources, wherein the user interface is operable to present the determined relevancy scores relative to the first and second predetermined groups of resources to the user.
